(19) United States
(12) Patent Application Publication
(10) Pub. No.: US 2006/0110013 A1
(43) Pub. Date: May 25, 2006

(54) Apparatus and method for inputting characters using fingerprint identification in portable wireless terminal

(75) Inventor: Eun Talk Lee, Suwon-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/285,714

(22) Filed: Nov. 22, 2005

(30) Foreign Application Priority Data
Nov. 25, 2004 (KR) 2004-0097226

(51) Int. Cl. G06K 9/00

(52) U.S. Cl. 382/115; 341/20; 455/411; 382/124

(57) ABSTRACT

Disclosed are an apparatus and method for inputting character using fingerprint identification in a portable wireless terminal. The apparatus includes a memory for storing a first database, in which a plurality of fingerprints are previously registered and a plurality of characters corresponding to the fingerprints are stored, and a second database, in which a dictionary is stored; a fingerprint identification pad for detecting and outputting input fingerprints; and a controller for retrieving the first database to check characters mapped for the respective fingerprints input from the fingerprint identification pad, and determining an input word by using the second database to combine the checked characters in an input order of the fingerprints.

### PRIORITY

This application claims priority under 35 U.S.C. §119 to an application entitled “Apparatus And Method For Inputting Character Using Fingerprint Identification In Portable Wireless Terminal” filed in the Korean Intellectual Property Office on Nov. 25, 2004 and assigned Ser. No. 2004-97226, the contents of which are incorporated herein by reference.

### BACKGROUND OF THE INVENTION

1. Field of the Invention

The present invention relates to an apparatus and method for inputting characters in a portable wireless terminal, and more particularly, to an apparatus and method for inputting characters using fingerprint identification in a portable wireless terminal.

2. Discussion of the Related Art

With the development of the electronic and communication industries, portable wireless terminals are becoming popular and are becoming more advanced to have compact, light-weight and multi-functional features to satisfy users' demand.

Through the use of software, the portable wireless terminals can provide a music download service and a Video-On-Demand (VOD) service, as well as a call service. Also, the portable wireless terminals can take photographs and store them in a photo album therein.

Regarding hardware, peripheral devices attachable to the portable wireless terminals are also being advanced. For example, an attachable built-in digital camera module, a TV tuner module for terrestrial broadcasting, and an MP3 player module are now available as peripheral devices.

Generally, portable wireless terminals are in the form of a foldable terminal that has a main body and a sub-body. The sub-body is rotatably coupled to the main body such that it is opened at a predetermined angle. Also, slide type terminals are available in the market, which are opened in a way that a sub body slides on a main body in a length direction by a predetermined distance. Bar type terminals are also available, as are rotatable terminals in which the sub-body rotates away from the main body in a parallel plane.

Input devices for portable wireless terminals having the various functions described above have also been developed. For example, a navigation keypad assembly has been added to a 3×4 keypad to operate various functions. In addition, there have been developed other key buttons provided on an outer surface of the sub-body, to allow the user to perform various functions without opening the portable wireless terminal. For example, the user can manipulate a replay/stop button of an MP3 player or take a photograph of an object.

With the increasing interest in biometrics-based personal identification, portable wireless terminals having a biometric module have recently been developed. Biometrics is the technology of authentication (i.e., establishing the identity of an individual) by measuring the person's biological or behavioral features. Compared with a conventional personal identification method using a password or token, the biometrics-based personal identification method is safer and more convenient. The biological features include fingerprint, retina, iris, face, hand, vein, voice, signature, smell, DNA, etc. Among them, fingerprint, voice, iris and face are widely used.

Specifically, fingerprint identification is one of the oldest biometrics-based identifications that have been successfully used in many applications. The fingerprint is an impression of the ridges in the skin of a finger and is unique to each individual. The fingerprint is considered to be more reliable and more stable than the retina, iris, vein and face, because the arrangement of ridges in any fingerprint is unique and permanent with each person.

As the demand for personal identification (user identification) using a handheld terminal in a mobile environment is increasing, a portable wireless terminal having a fingerprint identification module will be common. Accordingly, there is a demand for an application that allows the fingerprint identification module mounted on the portable wireless terminal to be used in various fields. As described above, various types of input devices are required because the functions that the portable wireless terminal can provide are becoming more complex and diverse. New input devices that are faster than the conventional input devices can be provided if ten unique fingerprints (two thumbs and eight fingerprints of left and right hands) of each person are used therein.

### SUMMARY OF THE INVENTION

The present invention provides a portable wireless terminal using a fingerprint identification pad as an input device.

Also, the present invention provides an apparatus and method for inputting characters using fingerprint identification in a portable wireless terminal.

According to an aspect of the present invention, there is provided a method for inputting characters using fingerprint identification in a portable wireless terminal, the portable wireless terminal having a first database, in which a plurality of fingerprints are previously registered and a plurality of characters corresponding to the fingerprints are stored, and a second database in which a dictionary is stored. The method includes retrieving the first database to check characters mapped for respective fingerprints input through a fingerprint identification pad; and determining an input word using the second database by combining the checked characters in an input order of the fingerprints.

According to another aspect of the present invention, there is provided an apparatus for inputting characters using fingerprint identification in a portable wireless terminal, the apparatus including a memory for storing a first database, in which a plurality of fingerprints are previously registered and a plurality of characters corresponding to the fingerprints are stored, and a second database, in which a dictionary is stored; a fingerprint identification pad for detecting and outputting input fingerprints; and a controller for retrieving the first database to check characters mapped for the respective fingerprints input from the fingerprint identification pad, and determining an input word using the second database by combining the checked characters in an input order of the fingerprints.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a folder type portable wireless terminal having a slide body on which a fingerprint identification pad is installed according to an embodiment of the present invention;

FIG. 2 is a block diagram of a portable wireless terminal having a fingerprint identification pad according to an embodiment of the present invention; and

FIG. 3 is a flowchart illustrating a method for inputting characters using fingerprint identification in a portable wireless terminal according to an embodiment of the present invention.

### DETAILED DESCRIPTION OF THE PREFERRED EMBODIMENTS

Reference will now be made in detail to the preferred embodiments of the present invention, examples of which are illustrated in the accompanying drawings. A detail description of well-known features will be omitted for conciseness.

Hereinafter, a technology for inputting characters using fingerprint identification in a portable wireless terminal will be described in detail. Herein, the term “character” will be used to refer to all characters, including English alphabet, Korean vowels and consonants, numbers, and special characters (for example, *, #, etc.), which can be inputted through a keypad of a portable wireless terminal.

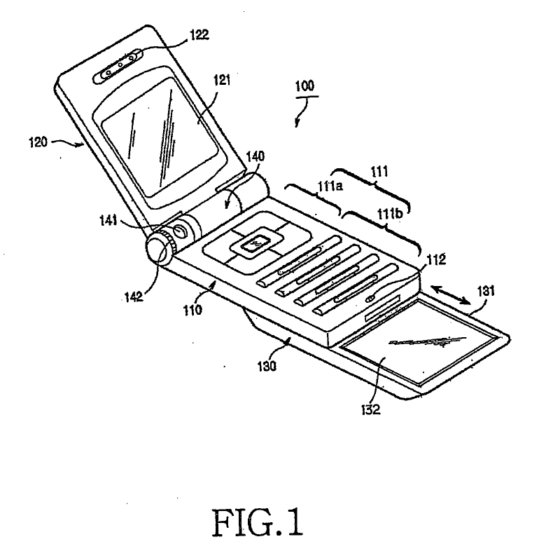

FIG. 1 is a perspective view of a folder type portable wireless terminal having a slide body on which a fingerprint identification pad is installed according to an embodiment of the present invention.

Referring to FIG. 1, the folder type portable wireless terminal 100 includes a main body 110, a sub body 120 installed above the main body 10, and a slide body 130 installed below the main body 110. An end portion of the sub body 120 is hinged to the main body 110 by means of a hinge module 140 such that the sub body 120 is rotatable around the end portion thereof at a predetermined angle. The slide body 130 operates to slide in a lengthwise direction of the portable wireless terminal 100.

A keypad assembly 111 including a plurality of key buttons is installed on the main body 110. The keypad assembly 111 may be configured with numeric key buttons 111b at a lower portion and navigation key buttons 111a at an upper portion. The navigation key buttons 111a can be used to execute various functions, such as a call function, an Internet connection, a phone number retrieval, and use of a digital camera or camcorder. A microphone 112 for converting sounds into electric signals is installed at a lower portion of the keypad assembly 111.

A display 121 is installed on the sub body 120. The display 121 may be a wide Liquid Crystal Display (LCD) module, preferably a wide color LCD module having tens to hundreds of pixels. An earpiece 122 for converting electric signals into sounds is installed at an upper portion of the display 121. In order to use the portable wireless terminal 100 as an image pickup device, a lens assembly 141 can be embedded on a side hinge arm of the main body 110. The lens assembly 141 is rotatable in a predetermined direction by means of an angle adjustment unit 142.

The slide body 130 is installed at a bottom of the main body 110 and is movable in a lengthwise direction as indicated by a double arrow. Preferably, the slide body 130 has the same length as the main body 110. The slide body 130 can slide out from beneath the main body 110 by half of an entire length of the slide body 130. The slide body 130 can be installed in the main body 110 by means of a known guide unit. For example, the sliding operation of the slide body 130 can be achieved by a guide rib and a guide groove engaged therewith.

Preferably, a fingerprint identification pad assembly 132 for scanning a fingerprint is installed on a surface of the slide body 130, which is exposed when the slide body 130 slides fully. Although the fingerprint identification pad assembly 132 is shown as being on the slide body 130, the present invention is not limited to that. For example, the fingerprint identification pad assembly can be instead installed in a position where the keypad assembly 111 is installed. Also, the fingerprint identification assembly can be installed in a lower portion of the keypad assembly 111 on the main body 110.

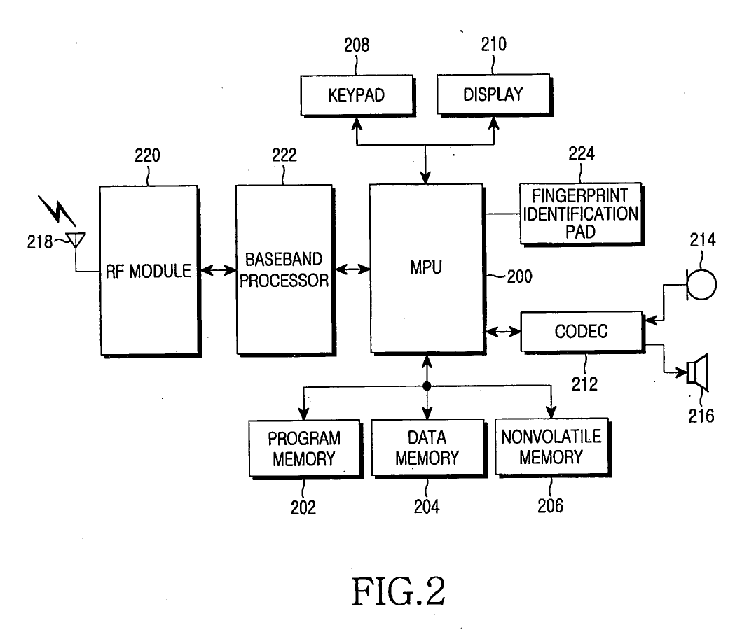

FIG. 2 is a block diagram of a portable wireless terminal having a fingerprint identification pad according to an embodiment of the present invention. It should be noted that the portable wireless terminal includes various kinds of mobile terminals, such as a cellular phone, a Personal Communication Service (PCS) phone, an International Mobile Communication-2000 (IMT-2000) phone, and a 4 G (OFDM: Orthogonal Frequency Division Multiplexing) phone. A following description will be made with a general structure of the terminals.

Referring to FIG. 2, a microprocessor unit (MPU) 200 controls an overall operation of the portable wireless terminal. For example, the MPU 200 processes and controls voice communication and data communication. In addition to the typical functions, the MPU 200 identifies an input fingerprint by comparing a fingerprint input through a fingerprint identification pad 224 with a fingerprint registered in advance, and checks stored characters corresponding to the identified fingerprint. Then, the MPU 200 processes a display function by carrying out a probability combination (e.g., T9-based probability combination) of the characters checked by the fingerprint identification using a dictionary. A description about the typical process and control operation of the MPU 200 will be omitted.

A memory includes a program memory 202, a data memory 204 and a nonvolatile memory 206. The program memory 202 stores a program for controlling an overall operation of the portable wireless terminal. A flash memory may be used for the program memory 202. The data memory 204 temporarily stores data that is created during the operation of the portable wireless terminal. A Random Access Memory (RAM) may be used for the data memory 204. The nonvolatile memory 206 stores system parameters and other data (e.g., SMS messages). An Electrically Erasable and Programmable Read Only Memory (EEPROM) may be used for the nonvolatile memory 206. In this embodiment, a dictionary database (English dictionary database, Korean dictionary database, etc.) and a character recognition database may be stored in the nonvolatile memory 206. The character recognition database defines ten registered fingerprints corresponding to two thumbs and eight fingers. In order to increase a fingerprint identification rate, a plurality of registered fingerprint data for one finger may be stored.

A keypad 208 includes numeric keys of digits 0-9 and a plurality of function keys, such as a Menu key, a Cancel (Delete) key, a Conformation key, a Talk key, an End key, an Internet connection key, and Navigation keys (Left/Right/Up/Down). A key input data corresponding to a key pressed by the user is transferred to the MPU 200. A display 210 displays status information (or indicator) of the portable wireless terminal, numerals and characters, moving pictures and still pictures, and the like. A color LCD may be used for the display 210.

A coder-decoder (CODEC) 212 connected to the MPU 200, a speaker 216 and a microphone 214 connected to the CODEC 212 are an audio input/output block that is used for a phone call. The MPU 200 produces pulse code modulated (PCM) data and the CODEC 212 converts the PCM data into analog audio signals. The analog audio signals are outputted through the speaker 216. Also, the CODEC 212 converts audio signals received through the microphone 214 into PCM data and provides the PCM data to the MPU 200.

A Radio Frequency (RF) module 220 down-converts RF signals received through an antenna 218 and provides the down-converted signal to a baseband processor 222. Also, the RF module 220 up-converts a baseband signal provided from the baseband processor 222 and transmits the up-converted baseband signal through the antenna 218. The baseband processor 222 processes the baseband signals that are transmitted/received between the RF module 220 and the MPU 200. For example, in the case of data transmission, the baseband processor 222 performs channel coding and spreading on the transmit data. In the case of data reception, the baseband processor 222 performs despreading and channel decoding on the received data.

A fingerprint identification pad 224 converts electric signals corresponding to fingerprint identification into digital data (image data) and outputs the digital data to the MPU 200. The fingerprint identification pad 224 is classified into an optical scanner type and a non-optical scanner type. In this embodiment, it is assumed that a non-optical sensor (thermal sensor, semiconductor sensor, LCD sensor, ultrasonic sensor, capacitor sensor, etc.) is used in the fingerprint identification pad. For example, an ATMEL thermal sensor, FCD 4 B 14, can be used.

An operation of the apparatus for inputting characters using fingerprint identification according to the present invention will now be described with reference to FIGS. 1 and 2. An input of an alphabet will be exemplarily described.

In this embodiment, alphabets corresponding to the respective fingerprints are stored according to a QWERTY keyboard format. Also, a plurality of alphabets corresponding to the respective fingerprints can be stored according to other formats (T9 keyboard format, user definition) other than the QWERTY keyboard format. It is assumed herein that the QWERTY keyboard format is used. The correlation between the fingerprints and the alphabets is shown in Table 1 below.

TABLE 1

| | | |
|---|---|---|
| Left Hand | Thumb | Small Letter/Capital Letter Toggle |
| | Index Finger | R F V T G B |
| | Middle Finger | E D C |
| | Ring Finger | W S X |
| | Little Finger | Q A Z |
| Right Hand | Thumb | Space Bar |
| | Index Finger | U J Y H N M |
| | Middle Finger | I K |
| | Ring Finger | O L |
| | Little Finger | P |

As can be seen from Table 1, when the inputted fingerprint is the middle finger of the left hand, it is determined that one of the characters E, D and C is inputted. When the inputted fingerprint is the middle finger of the right hand, it is determined that one of the characters I and K is inputted. Using the dictionary, the portable wireless terminal combines the characters inputted through the fingerprint identification and displays them. Accordingly, the database like Table 1 can be variously modified to provide user's convenience and reduce error in character combination. Meanwhile, the correlation between the fingerprint and the alphabet can be previously fixed by a developer or can be arbitrarily modified according to user definition.

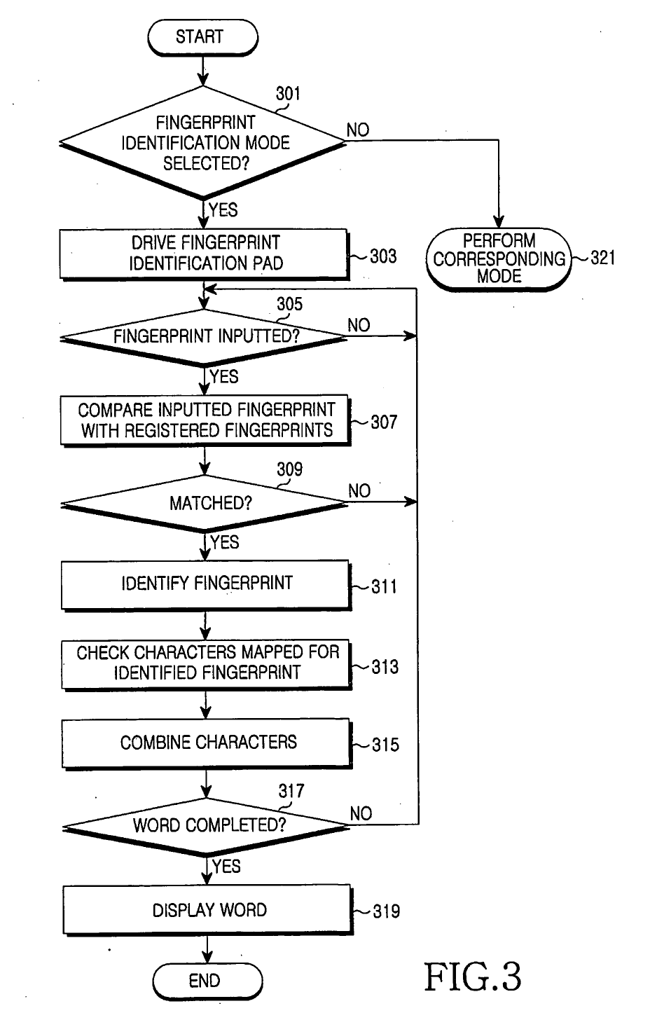

FIG. 3 is a flowchart illustrating a method for inputting characters using fingerprint identification in a portable wireless terminal according to an embodiment of the present invention. It is assumed that fingerprints of a user's two thumbs and eight fingers are registered in advance.

Referring to FIG. 3, in step 301, the MPU 200 checks whether a fingerprint identification mode is selected. For example, in the case of the portable wireless terminal illustrated in FIG. 1, the MPU 200 determines that the fingerprint identification mode is selected when the slide body 130 slides out from beneath the main body 110. In step 321, when the fingerprint identification mode is not selected, the MPU 200 executes a corresponding mode (e.g., a standby mode). In step 303, when the fingerprint identification mode is selected, the MPU 200 drives the fingerprint identification pad 224 by supplying a voltage thereto.

In step 305, the MPU 200 checks whether fingerprint data is input from the fingerprint identification pad 224. In step 307, when the fingerprint data is input, the MPU 200 compares the input fingerprint data with the ten previously registered fingerprint data. This process is generally called fingerprint matching. The fingerprint matching is achieved by comparing a feature data extracted from a current scanned fingerprint image with specific data previously registered. For example, the feature data is created using coordinates and angles of minute (bifurcation points and end points of fingerprint ridges). The extraction of the feature data and the fingerprint matching can be performed using a variety of known algorithms. In this embodiment, it is assumed that a known algorithm is used.

In step 309, after comparing the input fingerprint data with the previously registered fingerprint data, the MPU 200 checks whether there is the registered fingerprint data matching the input fingerprint data. When there is no registered fingerprint data matching the input fingerprint data, the process returns to step 305. On the contrary, in step 311, when there is the registered fingerprint data matches the input fingerprint data, the MPU 200 identifies which finger the input fingerprint data coincides with.

In step 313, after the identification of the input fingerprint, the MPU 200 retrieves a database, such as Table 1, and checks characters (alphabets) mapped for the identified fingerprint. In step 315, the MPU 200 combines the checked characters with the previously created character or character strings using the dictionary database (by comparing a possible word in the dictionary database) stored in the memory, and makes new character strings. In step 317, the MPU 200 checks whether new character strings created by the combination include a word defined in the dictionary database.

When the new character strings does not include a word defined in the dictionary database, the process returns to step 305. At this point, the new character strings are stored in a predetermined area of the memory and are again combined with characters input later. In step 319, when the new character strings include a word defined in the dictionary database, the MPU 200 displays the corresponding word on the display.

The characters can be combined at each input, or after an input of a space bar.

A detailed example will now be described for fully understanding the present invention.

It is assumed that fingerprints are inputted on the fingerprint identification pad in the following order:

R3→L3→R2→L3→R4→L5→L2→L3

where R and L represent the right hand and the left hand, respectively, and 1, 2, 3, 4 and 5 represent the thumb, the index finger, the middle finger, the ring finger, and the little finger, respectively.

The characters corresponding to the respective fingerprint inputs are summarized as Table 2 below.

TABLE 2

| I → | E → | Y → | R → | O → | Q → | R → | E |
|---|---|---|---|---|---|---|---|
| K | D | U | T | L | A | T | D |
| | C | H | F | | Z | F | C |
| | | J | G | | | G | |
| | | N | V | | | V | |
| | | M | B | | | B | |

Referring to Table 2, when a second input is received, a character string combined based on the dictionary is “ID”, “IC” and “KE”. When a third input is received, a character string combined is “ICY”, “KEY” and “KEN”. When a fourth input is received, a character string combined is “KEYB” and “KENT”. When a fifth input is received, a character string combined is “KEYBO”. When a sixth input is received, a character string combined is “KEYBOA”. When a seventh input is received, a character string combined is “KEYBOAR”. When a last input is received, character strings combined are “KEYBOARD”. That is, “KEYBOARD” is displayed on the display window.

As described above, the input efficiency in the small-sized portable wireless terminal can be remarkably improved by inputting characters using fingerprint identification. Specifically, in the case of the QWERTY keyboard format, the user can input characters in the same manner as a keyboard. Therefore, the user can input the characters faster and easier.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A method for inputting characters using fingerprint identification in a portable wireless terminal, the portable wireless terminal having a first database in which a plurality of fingerprints are previously registered and a plurality of characters corresponding to the fingerprints are stored, and a second database in which a dictionary is stored, the method comprising the steps of:
retrieving the first database to check characters mapped for respective fingerprints input through a fingerprint identification pad; and
identifying an input word by combining the checked characters in an input order of the fingerprints using the second database.

2. The method of claim 1, further comprising the step of displaying the identified word on a display.

3. The method of claim 1, wherein the first database is established based on a QWERTY keyboard format.

4. The method of claim 1, wherein the combining of the checked characters is carried out according to a T9-based probability combination.

5. A method for inputting characters using fingerprint identification in a portable wireless terminal, the portable wireless terminal having a first database in which a plurality of fingerprints are previously registered and a plurality of characters corresponding to the fingerprints are stored, and a second database in which a dictionary is stored, the method comprising the steps of:
identifying an input fingerprint by comparing the fingerprint input through a fingerprint identification pad with the plurality of registered fingerprints;
retrieving the first database to check characters mapped for the identified fingerprint;
creating new character strings using the second database to combine the checked characters and character strings produced by combining previously input fingerprints;
checking whether the new character strings include a word defined in the second database; and
when the new character strings include the word defined in the second database, displaying the corresponding word.

6. The method of claim 5, further comprising the steps of:
when the new character strings do not include the word defined in the second database, storing the new character strings in a specific area of a memory so as to combine the new character string and characters input later; and
returning to the step of identifying the fingerprint.

7. The method of claim 5, wherein the first database is established based on a QWERTY keyboard format.

8. The method of claim 5, wherein the combination of the characters is carried out according to a T9-based probability combination.

9. An apparatus for inputting characters using fingerprint identification in a portable wireless terminal, the apparatus comprising:
a memory for storing a first database, in which a plurality of fingerprints are previously registered and a plurality of characters corresponding to the fingerprints are stored, and a second database, in which a dictionary is stored;
a fingerprint identification pad for detecting and outputting input fingerprints; and
a controller for retrieving the first database to check characters mapped for the respective fingerprints input from the fingerprint identification pad, and identifying an input word by combining the checked characters in an input order of the fingerprints using the second database.

10. The apparatus of claim 9, further comprising a display for displaying the identified word.

11. The apparatus of claim 9, wherein the first database is established based on a QWERTY keyboard format.

12. The apparatus of claim 9, wherein the combining of the checked characters is carried out according to a T9-based probability combination.

13. An apparatus for inputting characters using fingerprint identification in a portable wireless terminal, the apparatus comprising:
a memory for storing a database, in which a plurality of fingerprints are previously registered and a plurality of characters corresponding to the fingerprints are stored,
a fingerprint identification pad for inputting fingerprints; and
a controller for comparing characters mapped for the respective fingerprints with input fingerprints, and identifying an input word by combining the mapped characters in an input order of the fingerprints.

14. The apparatus of claim 13, further comprising a display for displaying the identified input word.

15. The apparatus of claim 13, wherein the database is established based on a QWERTY keyboard format.

16. A method for inputting characters using fingerprint identification in a portable wireless terminal, the portable wireless terminal having a memory for registering fingerprints, for storing characters corresponding to the registered fingerprints, and for storing a dictionary, the method comprising the steps of:
checking the memory for characters mapped for respective fingerprints input through a fingerprint identification pad; and
identifying an input word by combining the checked characters in an input order of the fingerprints using the memory.
